(19) United States
(12) Patent Application Publication
(10) Pub. No.: US 2025/0068162 A1
(43) Pub. Date: Feb. 27, 2025

(54) OPEN-PIT MINE TRUCK AUTOMATIC DISPATCHING SYSTEM AND METHOD

(71) Applicants: WSGRI ENGINEERING & SURVEYING INCORPORATION LIMITED, WUHAN (CN); WSGRI SMART CITY(WUHAN) ENGINEERING TECHNOLOGY CO.,LTD., WUHAN (CN)

(72) Inventors: ZHONGHAI ZANG, WUHAN (CN); SHUMIN XIONG, WUHAN (CN); SHUGANG ZHAO, WUHAN (CN); LEI HE, WUHAN (CN); CHUNQING HU, WUHAN (CN); HUI LI, WUHAN (CN); WENJIE YU, WUHAN (CN); SIYUAN HAN, WUHAN (CN); KE XU, WUHAN (CN); FENG WU, WUHAN (CN); YAHUI WU, WUHAN (CN)

(21) Appl. No.: 18/505,059

(22) Filed: Nov. 8, 2023

(30) Foreign Application Priority Data
Aug. 25, 2023 (CN) 202311096237.X

(51) Int. Cl. G05D 1/02; G05D 1/00

(52) U.S. Cl. CPC G05D 1/0212

(57) ABSTRACT

An open-pit mine truck automatic dispatching system and method, which comprises a digital twin creation module and a driver terminal; the digital twin creation module creates the dispatcher digital twin, the dispatcher digital twin receives the production plan, and creates the loader digital twin, the unloading point digital twin, the truck digital twin and the transportation path digital twin according to the production plan. The driver terminal obtains the available information of loaders and trucks and sends the available information to the dispatcher digital twin; the dispatcher digital twin generates dispatching commands based on available information, schedules the loader digital twin and the truck digital twin based on the dispatching command, and updates the property information of the loader digital twin, the unloading point digital twin, the truck digital twin and the transportation path digital twin. The invention realizes the automatic dispatching of open-pit mine trucks.

### FIELD OF THE DISCLOSURE

The disclosure relates to production dispatching, and particularly to an open-pit mine truck automatic dispatching system and method.

### BACKGROUND

Open-pit mine is a large-scale production system with mining as the center and transportation as the link. The completion of the production planning task, the organization and implementation of the production process are accomplished through the acquisition and transportation equipment, especially the real-time deployment of transportation equipment. Whether the traffic flow allocation is reasonable will directly affect the production efficiency and economic benefit of the whole production system of the open-pit mine.

The traditional way of vehicle flow allocation is manual management, but the manual management is relatively extensive, high labor cost, low efficiency, and not timely response to abnormal situations. In order to solve the above problems in manual management mode, this paper proposes to use computer to access truck dispatching system to realize automatic dispatching. However, it has the following technical problems: the computer intervention in the truck dispatching system in the prior art is mainly to monitor the truck or loader, obtain monitoring information, and then process the monitoring information based on the manual, and carry out dispatching control. That is, a large number of manual operations are still needed in the implementation of dispatching, and the ability to handle abnormal cases is relatively weak.

Therefore, it is urgent to put forward an automatic dispatching system and method for open-pit mine trucks to solve the above technical problems.

### SUMMARY

In view of this, it is necessary to provide an automatic dispatching system and method for open-pit mine trucks to solve the technical problems that manual participation in open-pit mine trucks dispatching leads to a low degree of dispatching automation and a weak ability to handle abnormal situations.

In one aspect, the invention provides an open-pit mine truck automatic dispatching system, which comprises: digital twin creation module and driver terminal;
the digital twin creation module is used to create a dispatcher digital twin, and the dispatcher digital twin is used to receive a production plan and create at least one loader digital twin, at least one unloading point digital twin, at least one truck digital twin and at least one transportation path digital twin according to the production plan;
the driver terminal is used to obtain the available information of the loader and truck and send the available information to the dispatcher digital twin;
the dispatcher digital twin is also used to generate dispatching instructions based on the available information and to schedule the loader digital twin and the truck digital twin based on the dispatching instruction, updating the property information of the loader digital twin, the unloading point digital twin, the truck digital twin, and the transportation path digital twin.

In some possible implementations, the available information includes login information, real-time information and at least one of the fault information, the dispatching instruction includes a loader dispatching instruction and a truck dispatching instruction, and the driver terminal includes a truck driver terminal and a loader driver terminal.

In some possible implementations, the attribute information of the loader digital twin includes the loader number, the loader name, the muck pile number, the muck pile name, the loading capacity per hour, the planned output of the loader, the completed output of the loader, the planned time, the current position information of the loader, the dispatched fleet of the loader and the status of the loader; the attribute information of the truck digital twin includes truck number, truck name, marked load, starting point number, target point number and the state of the truck itself; the attribute information of the unloading point digital twin includes unloading point number, unloading point name, hourly throughput, unloading point planned output, unloading point completed output, cumulative taste, unloading point location coordinates, unloading point dispatched fleet and unloading point status; the attribute information of the transportation path digital twin includes path start number, path end number, empty vehicle flow rate and heavy vehicle flow rate.

In some possible implementations, when the available information is login information;
the dispatcher digital twin is used to distribute the login information to the loader digital twin and the truck digital twin;
the loader digital twin is used to generate the loader dispatching instruction based on the login information and send the loader dispatching instruction to the loader driver terminal;
the truck digital twin is used to determine whether the login information belongs to the work login or repeated login based on the truck's own state, if the work login, the request information is generated based on the login information, and the request information is sent to the dispatcher digital twin, if the repeat login, the last truck dispatching command is sent to the truck driver terminal;
the dispatcher digital twin is also used to generate a truck dispatching command based on the request information and send the truck dispatching command to the truck digital twin;
the truck digital twin is also used to update the property information of the truck digital twin according to the truck dispatching instruction and send the truck dispatching instruction to the truck driver terminal;
the truck digital twin is also used to determine the first target loader digital twin and the first target unload point digital twin associated with the truck digital twin, and update the loader dispatched fleet list of the first target loader digital twin and the unloading point dispatched fleet list of the first target unload point digital twin.

In some possible implementations, when the available information is real-time information;
the dispatcher digital twin is used to distribute the real-time information to the loader digital twin and the truck digital twin;
the loader digital twin is used to update and save the loader digital twin's own attribute information based on the real-time information;
the truck digital twin is used to determine whether it is necessary to send empty car information or heavy car dispatching information to the dispatcher digital twin based on its own state;
the dispatcher digital twin is also used to generate the truck dispatching command when receiving the empty vehicle request information or heavy vehicle dispatch information sent by the truck digital twin;
the truck digital twin is also used to update the property information of the truck digital twin according to the truck dispatching instruction and send the truck dispatching instruction to the truck driver terminal;
the truck digital twin is also used to determine the second target loader digital twin and the second target unload point digital twin associated with the truck digital twin, and update the loader dispatched fleet list of the second target loader digital twin and the unloading point dispatched fleet list of the second target unload point digital twin.

In some possible implementations, when the available information is fault information;
the dispatcher digital twin is used to judge the type of fault occurrence according to the fault information.
when the fault type is a loader fault, identifying the target fault loader digital twin that has failed, and the truck digital twin that has been dispatched to the target fault loader digital twin weight new vehicles, and clearing the list of dispatched vehicles of the target fault loader digital twin;
when the fault occurs in the dispatched air cargo truck, the faulty target air cargo truck digital twin and the first target associated loader digital twin corresponding to the target faulty air cargo truck digital twin are identified, and the target faulty air cargo truck digital twin is deleted from the dispatched vehicle list property of the first target associated loader digital twin;
when the fault occurs type heavy truck fault, determining the target fault heavy truck digital twin and the second target fault heavy truck digital twin corresponding to the target fault heavy truck digital twin, and deleting the target fault heavy truck digital twin from the dispatched vehicle list property of the second target fault heavy truck digital twin, and reduce the completion of production.

In some possible implementations, the attribute information of the truck digital twin also includes the current position information of the truck, and the dispatcher digital twin is also used to determine the pending warning truck digital twin and the pending warning loader digital twin based on the current position information of the truck, the current position information of the loader and the search range; the anti-collision warning information is sent to the digital twin of the waiting truck and the digital twin of the waiting loader.

In some possible implementations, the production plan includes a production end time, and the dispatcher digital twin is also used to send off orders to the loader digital twin and the truck digital twin when the time reaches the production end time;
the dispatcher digital twin is also used to respond to the exit notification of the driver terminal and send the exit notification to the loader digital twin and the truck digital twin;

The loader digital twin and the truck digital twin are used to respond to the exit notification and set their own state to offline.

In some possible implementations, the dispatcher digital twin is also used to destroy the loading machine digital twin, the unloading point digital twin, the truck digital twin, the transport path digital twin and the dispatcher digital twin when the loader digital twin and the truck digital twin are in an offline state.

In another aspect, the invention provides an open-pit mine truck automatic dispatching method, the method applicable to the open-pit mine truck automatic dispatching system described in any of possible implementations, and the open-pit mine truck automatic dispatching method includes:
creating a dispatcher digital twin to receive a production plan based on the dispatcher digital twin, and create at least one loader digital twin, at least one unloading point digital twin, at least one truck digital twin, and at least one transportation path digital twin based on the production plan;
obtaining the available information for loaders and trucks and send the available information to the dispatcher digital twin;
controlling dispatcher digital twin generates dispatching instructions, the loader digital twin and the truck digital twin are dispatched based on the dispatching instruction, updating the property information of the loader digital twin, the unloading point digital twin, the truck digital twin, and the transportation path digital twin.

The beneficial effects of the above implementation are: the open-pit mine truck automatic dispatching system provides a dispatcher digital twin by setting a digital twin creation module, and the dispatcher digital twin creates at least one loader digital twin, at least one unloading point digital twin, at least one truck digital twin and at least one transportation path digital twin according to the production plan. A virtual open-pit mine transportation system is formed, and the digital twins in the virtual world and their connections are used to simulate and analyze the transportation process in the real world, reduce manual intervention, and realize the automatic and intelligent dispatching of open-pit mine truck transportation. Moreover, by simulating the abnormal situation in the digital twin, the real world transportation process can respond to the abnormal situation in time, and the real-time of truck dispatching can be improved.

Furthermore, each digital twin can describe the logical structure of the production and transportation process of any complex open-pit mine mine, and it is easy to implement, with strong fault tolerance and high dispatching precision.

### BRIEF DESCRIPTION OF THE DRAWINGS

Many aspects of the present implementation can be better understood with reference to the following drawings. The components in the drawings are not necessarily drawn to scale, the emphasis instead being placed upon clearly illustrating the principles of the present implementation. Moreover, in the drawings, all the views are schematic, and like reference numerals designate corresponding parts throughout the several views.

FIG. 1 is a schematic diagram of an implementation of an open-pit mine truck automated dispatching system provided by the invention.

FIG. 2 is a schematic diagram of a production and transportation plan for a production shift in an open-pit mine.

FIG. 3 is a schematic diagram of an implementation of a digital twin in an open-pit mine truck automated dispatching system provided by the invention.

FIG. 4 is a schematic diagram of an implementation of an open-pit mine truck automated dispatching method provided by the invention.

### DETAILED DESCRIPTION

The following is a clear and complete description of the technical scheme in the implementation of the invention in combination with the drawings in the implementation of the invention. Obviously, the implementations described are only partial implementations of the invention and not all implementations. Based on the implementations of the invention, all other implementations obtained by a person skilled in the art without creative labor fall within the scope of protection of the invention.

It should be understood that the schematic drawings are not drawn to physical scale. The process diagram used in the invention shows the operation realized according to some implementations of the invention. It should be understood that flowchart operations can be implemented out of sequence, and steps without logical context can be reversed or implemented simultaneously. In addition, a person skilled in the art may, guided by the contents of the present invention, add one or more other operations to the flow chart or remove one or more operations from the flow chart.

References to “implementations” herein imply that specific features, structures or properties described in conjunction with implementations may be included in at least one implementation of the present invention. The presence of the phrase at various points in the specification does not necessarily refer to the same implementation, nor is it a separate or alternative implementation that is mutually exclusive with other implementations. It is understood explicitly and implicitly by those skilled in the art that implementations described herein may be combined with other implementations.

FIG. 1 is a schematic diagram of an implementation of the open-pit mine truck automatic dispatching system provided by the invention, as shown in FIG. 1. The open-pit mine truck automatic dispatching system 10 comprises: digital twin creation module 100 and driver terminal 200;
the digital twin creation module 100 is used to create the dispatcher digital twin 110, the dispatcher digital twin 110 is used to receive production plans, Create at least one loader digital twin 111, at least one unloading point digital twin 112, at least one truck digital twin 113 and at least one transportation path digital twin 114 according to the production plan; the driver Terminal 200 is used to obtain the available information for loaders and trucks and send the available information to the dispatcher digital twin 110;
the dispatcher digital twin 110 is also used to generate dispatching instructions based on available information, schedule the loader digital twin 111 and the truck digital twin 113 based on dispatching instructions, and update the property information of the loader digital twin 111, the unloading point digital twin 112, the truck digital twin 113, and the transportation path digital twin 114.

The beneficial effects of the above implementation are: The open-pit mine truck automatic dispatching system provides a dispatcher digital twin by setting a digital twin creation module, and the dispatcher digital twin creates at least one loader digital twin, at least one unloading point digital twin, at least one truck digital twin and at least one transportation path digital twin according to the production plan. A virtual open-pit mine transportation system is formed, and the digital twins in the virtual world and their connections are used to simulate and analyze the transportation process in the real world, reduce manual intervention, and realize the automatic and intelligent dispatching of open-pit mine truck transportation. Moreover, by simulating the abnormal situation in the digital twin, the real world transportation process can respond to the abnormal situation in time, and the real-time of truck dispatching can be improved.

Furthermore, each digital twin can describe the logical structure of the production and transportation process of any complex open-pit mine, and it is easy to implement, with strong fault tolerance and high dispatching precision.

As shown in FIG. 1, the driver terminal 200 includes the loader driver terminal 210 and the truck driver terminal 220.

To be clear: The loader digital twin 111, the unloading point digital twin 112, the truck digital twin 113, and the transportation path digital twin 114 all require a certain physical operating environment, and the driver terminal 200 also requires a certain physical operating environment. The physical operating environment of each digital twin refers to the server with memory, disk, display, and keyboard and mouse. The physical operating environment of driver Terminal 200 refers to the on-board industrial intelligent terminal equipment with display screen, speaker and microphone that can access high-precision positioning equipment, 4G\5G communication equipment, smart sensors.

Further, since the dispatcher's digital twin 110, the loader's digital twin 111, the unloading point digital twin 112, the truck's digital twin 113, the transportation path's digital twin 114, and the driver terminal 200 need to communicate, a physical communication link needs to be established. Specifically, the physical communication link refers to the 4G\5G wireless network, and the communication platform is required when the dispatcher digital twin 110, the loader digital twin 111, the unloading point digital twin 112, the truck digital twin 113, the transportation path digital twin 114, and the driver terminal 200 communicate with each other. Communication platform refers to message middleware platform.

In specific implementations of the invention, the following steps are required before creating the dispatcher digital twin 110 through the digital twin creation module 100: Set up a server with a display, keyboard and mouse with a memory of not less than 64G and a disk of not less than 4T, and install winserver2016\SQLServer2016 and above versions of the operating system, database software and message middleware platform on the server. Install on the truck that can access external high-precision positioning equipment, 4G\5G communication equipment, smart sensors, on-board industrial-grade intelligent terminals with display screens, speakers and microphones, and build 4G\5G wireless networks covering open-pit mine mining sites.

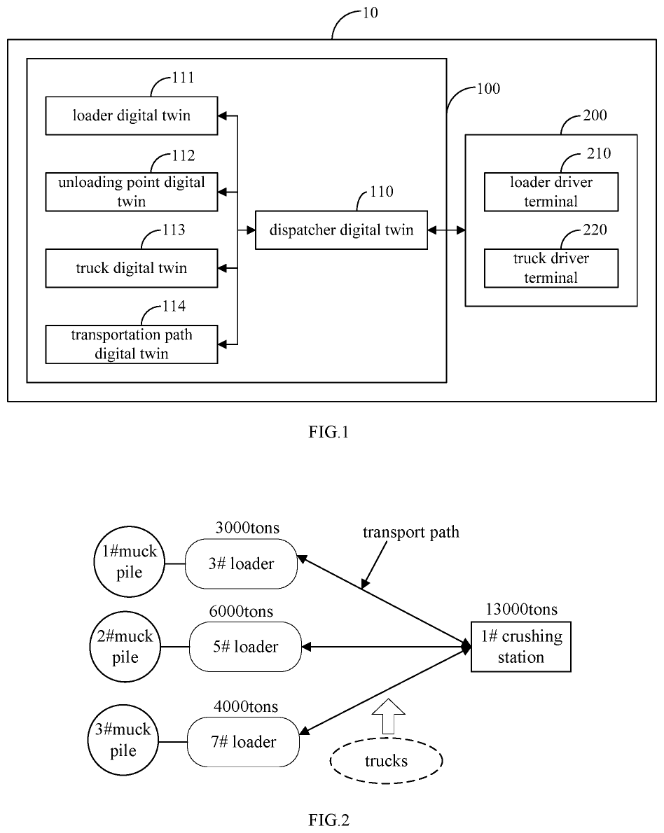

In some implementations of the invention, FIG. 2 is a schematic diagram of a production and transportation plan for a production shift in an open-pit mine. The shift plans to transport ore from 3 muck piles, such as 1 #, 2 # and 3 #, respectively to 1 # crushing station, with a planned period of 8 hours, wherein the ore output of 1 # muck pile is 3,000 tons, and that of 2 #muck pile is 6,000 tons. The ore output of the 3 # muck pile is 4000 tons, the ore output of the 1 # crushing station is 13,000 tons, the 3 # loader is allocated to the 1 # muck pile, the 5 # loader is allocated to the 2 # muck pile, and the 7 # loader is allocated to the 3 # muck pile. In order to complete the transportation plan of this shift, a total of 20 mining trucks with a labeled load of 50 tons are arranged.

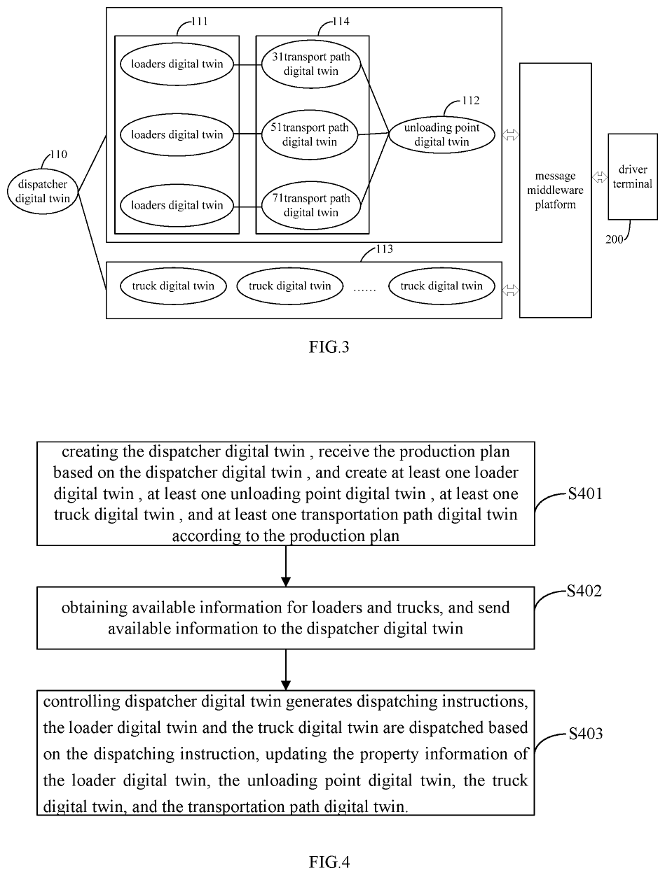

The digital twin created in the open-pit mine truck automatic dispatching system 10 is shown in FIG. 3. The dispatcher digital twin 110, three loaders digital twin 111, 20 truck digital twin 113, 1 #unloading point (crushing station) digital twin 112, 31 transport path digital twin 114, 51 transport path digital twin 114, 71 transport path digital twin 114 were established by object-oriented method. The production plan also includes the execution time and dispatching mode of the production plan. The dispatching mode of this plan is free dispatching. The behavior of the dispatcher digital twin 110 includes the execution and termination of the production plan, the traffic flow planning of the production plan, and the exception handling of the equipment that fails to work due to faults.

Specifically: the planned output of the 1 #loader digital twin 111 is 3000T, the loading capacity is 500T per hour, and the assigned muck pile is 1 #muck pile; the planned output of the 2 #loader digital twin 111 is 5500T, the loading capacity is 700T per hour, and the assigned muck pile is 2 #muck pile; the planned output of the 3 #loader digital twin 111 is 4000T, the loading capacity is 500T per hour, and the assigned muck pile is 3 #muck pile; the planned output of the 1 #unloading point (crushing station) digital twin 112 is 4000T, and the unloading capacity per hour is 1750T, where T represents the unit ton.

In specific implementations of the invention, the available information includes at least one of the login information, real-time information and fault information, and the dispatching instruction includes the loader dispatching instruction and the truck dispatching instruction.

By setting at least one of the available information, including login information, real-time information and fault information, the implementation of the invention can realize the simulation of multiple situations in the open-pit mine through digital twins, and improve the fault-tolerant capability of the open-pit mine truck automatic dispatching system 10.

In the specific implementation of the present invention, the attribute information of the loader digital twin 111 includes the loader number, loader name, muck pile number, muck pile name, loading capacity per hour, loader planned output, loader completed output, planned time, loader current position information, loader dispatched fleet and loader status; the attribute information of the truck digital twin 113 includes the truck number, truck name, marked load, starting point number, target point number and the state of the truck itself, the attribute information of the unloading point digital twin 112 includes the unloading point number, unloading point name, throughput per hour, unloading point planned output, unloading point completed output, cumulative taste, unloading point location coordinates, unloading point dispatched fleet and unloading point status, the attribute information of the transportation path digital twin 114 includes the path start number, path end number, empty vehicle flow, and heavy vehicle flow.

Among them, the loader status is online/offline, working/idle/other, fault and so on.

Truck status includes working status and maintenance status. Working status includes login (online), exit (offline), disconnected, air transport, waiting for loading, loading, heavy transport, waiting for unloading, and unloading. Online status, exit status (offline), and disconnected status are mutually exclusive and can coexist with other states.

Maintenance state includes refueling, first fault, second fault, maintenance four kinds.

The unloading point status includes working, stopping and fault states.

In specific implementations of the invention, the information format of the login information is: * Working, terminal number, device type, time #. Among them, the equipment types are divided into loaders and trucks, respectively denoted by D and T. The format of real-time information is: * RS, terminal number, V1, time information, S, longitude, D, dimension, G, speed, date information, device status, device type #. The fault information is in the following format: * RS, terminal number, 19, time, login ID, device number, 2, fault information, latitude, longitude, and A #. Fault types include those that do not affect production and those that affect production, which are represented by A and B respectively.

In some implementations of the invention, when the available information is login information;
the dispatcher digital twin 110 is used to distribute login information to the loader digital twin 111 and the truck digital twin 113;
the loader digital twin 111 is used to generate loader dispatching instructions based on login information and send the loader dispatching instructions to the loader driver terminal 210;
the truck digital twin 113 is used to determine whether the login information belongs to work login or repeated login based on the status of the truck itself. If it is work login, the request information is generated based on the login information and sent to the dispatcher digital twin 110. If it is repeated login, the last truck dispatching command is sent to the truck driver terminal 220. the dispatcher digital twin 110 is also used to generate truck dispatching instructions based on request information and send truck dispatching instructions to the truck digital twin 113.
the truck digital twin 113 is also used to update the property information of the truck digital twin 113 according to the truck dispatch command and send the truck dispatch command to the truck driver terminal 220;
the truck digital twin 113 is also used to determine the first target loader digital twin and the first target unload point digital twin associated with the truck digital twin 113, and update the loader dispatched fleet list for the first target loader digital twin and the unloading point dispatched fleet list for the first target unload point digital twin.

Among them, the format of the loader dispatching instruction is: RS, destination terminal number, kl, dispatching issue time, destination name (loader or unloading point or muck pile name), issue date, material type, dispatching information #.

In some implementations of the invention, when the available information is real-time information;
the dispatcher digital twin 110 is used to distribute real-time information to the loader digital twin 111 and truck digital twin 113;
loader digital twin 111 is used to update and save the property information of loader digital twin 111 based on real-time information;
the truck digital twin 113 is used to determine whether it is necessary to send empty or heavy vehicle call information to the dispatcher digital twin 110 based on its own state;
the dispatcher digital twin 110 is also used to generate truck dispatching commands when receiving the empty or heavy truck dispatching message from the truck digital twin 113;
the truck digital twin 113 is also used to update the property information of the truck digital twin 113 according to the truck dispatch command and send the truck dispatch command to the truck driver terminal 220;
the truck digital twin 113 is also used to determine the second target loader digital twin and the second target unload point digital twin associated with the truck digital twin 113, and update the loader dispatched fleet list for the second target loader digital twin and the unload point dispatched fleet list for the second target unload point digital twin.

In some implementations of the invention, when the available information is fault information;

The dispatcher digital twin 110 is used to determine the fault type based on the fault information.

When the fault type is a loader fault, identifying the faulty target loader digital twin, redeploy the truck digital twin 113 that has been dispatched to the target loader digital twin, and clearing the list of dispatched vehicles for the target loader digital twin;

When the fault occurs in the dispatched air cargo truck, the faulty target air cargo truck digital twin and the first target associated loader digital twin corresponding to the target faulty air cargo truck digital twin are identified, and the target faulty air cargo truck digital twin is deleted from the dispatched vehicle list attribute of the first target associated loader digital twin.

When a heavy truck fault occurs, the faulty digital twin of the target faulty heavy truck and the second target associated loader digital twin corresponding to the target faulty heavy truck digital twin are determined, and the target faulty heavy truck digital twin is deleted from the dispatched vehicle list attribute of the second target associated loader digital twin, and the completed production is reduced.

In order to avoid collision events between vehicles during transportation and cause safety problems, in some implementations of the invention, the attribute information of the truck digital twin 113 also includes the current position information of the truck. The dispatcher digital twin 110 is also used to determine the digital twin of the pending truck and the digital twin of the pending loader based on the current position information of the truck, the current position information of the loader and the search range, and to send the collision warning information to the digital twin of the pending truck and the digital twin of the pending loader.

The implementation of the invention can avoid collision events between vehicles by sending anti-collision warning information to the digital twin of the truck to be warned and the digital twin of the loader to be warned, and improve the safety during the completion of the production plan.

In the specific implementation of the invention, the information format of the anti-collision Warning information is: * Warning, terminal number, list of nearby vehicle terminal number, time #.

In some implementations of the invention, the production plan includes the production end time, and the dispatcher digital twin 110 is also used to send off orders to the loader digital twin 111 and the truck digital twin 113 when the production end time is reached;
the dispatcher digital twin 110 is also used to respond to exit notifications from the driver terminal 200 and send exit notifications to the loader digital twin 111 and the truck digital twin 113;
the loader digital twin 111 and the truck digital twin 113 are used to respond to exit notifications and set their own state to offline.

Specifically, the loader digital twin 111 and the truck digital twin 113 respond to an exit notification and send off dispatch instructions to their corresponding truck driver terminals 220 and 210, setting their own state to offline.

Among them, the message format of the off-duty dispatching instruction is: #Stop, terminal number, time, please leave work #.

In some implementations of the invention, the dispatcher digital twin 110 is also used when the loader digital twin 111 and the truck digital twin 113 are themselves offline. Destroy the loader digital twin 111, the unloading point digital twin 112, the truck digital twin 113, the transport path digital twin 114, and the dispatcher digital twin 110.

The implementation of the invention also provides an automatic dispatching method for open-pit mine trucks, which is applicable to the automatic dispatching system for open-pit mine trucks in any of the above implementations, as shown in FIG. 4. The automatic dispatching method for open-pit mine trucks comprises:
S401, creating the dispatcher digital twin 110, receive the production plan based on the dispatcher digital twin 110, and create at least one loader digital twin 111, at least one unloading point digital twin 112, at least one truck digital twin 113, and at least one transportation path digital twin 114 according to the production plan;
S402, obtaining available information for loaders and trucks, and send available information to the dispatcher digital twin 110;
S403, controlling dispatcher digital twin110 generates dispatching instructions, the loader digital twin111 and the truck digital twin113 are dispatched based on the dispatching instruction, updating the property information of the loader digital twin111, the unloading point digital twin112, the truck digital twin113, and the transportation path digital twin114.

The above implementations provide an automatic dispatching method for open-pit mine trucks that can realize the technical scheme described in the above implementations of the automatic dispatching system for open-pit mine trucks. The principle of the specific implementation of the above processes can be referred to the corresponding content in the implementations of the automatic dispatching system for open-pit mine trucks, which will not be repeated here.

It is understood by those skilled in the art that all or part of the process to implement the above implementations may be accomplished by instructing the relevant hardware by means of a computer program, which may be stored in a computer readable storage medium. Among them, the computer readable storage medium is disk, optical disc, read-only storage memory or random storage memory.

The above mentioned open-pit mine truck automatic dispatching system and method provided by the invention are introduced in detail, and the principle and implementation mode of the invention are described in this paper with specific examples. The illustration of the above implementation is only used to help understand the method and its core idea of the invention; At the same time, for the technical personnel in the field, according to the idea of the invention, there will be changes in the specific mode of implementation and scope of application, in summary, the content of this specification should not be understood as a limitation of the invention.

What is claimed is:

1. An open-pit mine truck automatic dispatching system, comprising a digital twin creation module and a driver terminal;
the digital twin creation module is used to create a dispatcher digital twin, and the dispatcher digital twin is used to receive a production plan and create at least one loader digital twin, at least one unloading point digital twin, at least one truck digital twin and at least one transportation path digital twin according to the production plan;
the driver terminal is used to obtain the available information of the loader and truck and send the available information to the dispatcher digital twin;
the dispatcher digital twin is also used to generate dispatching instructions based on the available information and to schedule the loader digital twin and the truck digital twin based on the dispatching instruction, updating the property information of the loader digital twin, the unloading point digital twin, the truck digital twin, and the transportation path digital twin.

2. The open-pit mine truck automatic dispatching system of claim 1, wherein the available information includes at least one of the login information, real-time information and fault information, the dispatching instruction includes a loader dispatching instruction and a truck dispatching instruction, and the driver terminal includes a truck driver terminal and a loader driver terminal.

3. The open-pit mine truck automatic dispatching system of claim 2, wherein the attribute information of the loader digital twin includes the loader number, the loader name, the muck pile number, the muck pile name, the loading capacity per hour, the planned output of the loader, the completed output of the loader, the planned time, the current position information of the loader, the dispatched fleet of the loader and the status of the loader; the attribute information of the truck digital twin includes truck number, truck name, marked load, starting point number, target point number and the state of the truck itself; the attribute information of the unloading point digital twin includes unloading point number, unloading point name, hourly throughput, unloading point planned output, unloading point completed output, cumulative taste, unloading point location coordinates, unloading point dispatched fleet and unloading point status; the attribute information of the transportation path digital twin includes path start number, path end number, empty vehicle flow rate and heavy vehicle flow rate.

4. The open-pit mine truck automatic dispatching system of claim 3, wherein when the available information is login information;
the dispatcher digital twin is used to distribute the login information to the loader digital twin and the truck digital twin;
the loader digital twin is used to generate the loader dispatching instruction based on the login information and send the loader dispatching instruction to the loader driver terminal;
the truck digital twin is used to determine whether the login information belongs to the work login or repeated login based on the truck's own state, if the work login, the request information is generated based on the login information, and the request information is sent to the dispatcher digital twin, if the repeat login, the last truck dispatching command is sent to the truck driver terminal;
the dispatcher digital twin is also used to generate a truck dispatching command based on the request information and send the truck dispatching command to the truck digital twin;
the truck digital twin is also used to update the property information of the truck digital twin according to the truck dispatching instruction and send the truck dispatching instruction to the truck driver terminal;
the truck digital twin is also used to determine the first target loader digital twin and the first target unload point digital twin associated with the truck digital twin, and update the loader dispatched fleet list of the first target loader digital twin and the unloading point dispatched fleet list of the first target unload point digital twin.

5. The open-pit mine truck automatic dispatching system of claim 3, wherein when the available information is real-time information;
the dispatcher digital twin is used to distribute the real-time information to the loader digital twin and the truck digital twin;
the loader digital twin is used to update and save the loader digital twin's own attribute information based on the real-time information;
the truck digital twin is used to determine whether it is necessary to send empty car information or heavy car dispatching information to the dispatcher digital twin based on its own state;
the dispatcher digital twin is also used to generate the truck dispatching command when receiving the empty vehicle request information or heavy vehicle dispatch information sent by the truck digital twin;
the truck digital twin is also used to update the property information of the truck digital twin according to the truck dispatching instruction and send the truck dispatching instruction to the truck driver terminal;
the truck digital twin is also used to determine the second target loader digital twin and the second target unload point digital twin associated with the truck digital twin, and update the loader dispatched fleet list of the second target loader digital twin and the unloading point dispatched fleet list of the second target unload point digital twin.

6. The open-pit mine truck automatic dispatching system of claim 3, wherein when the available information is fault information;
the dispatcher digital twin is used to judge the type of fault occurrence according to the fault information.
when the fault type is a loader fault, identifying the target fault loader digital twin that has failed, and the truck digital twin that has been dispatched to the target fault loader digital twin weight new vehicles, and clearing the list of dispatched vehicles of the target fault loader digital twin;
when the fault occurs in the dispatched air cargo truck, the faulty target air cargo truck digital twin and the first target associated loader digital twin corresponding to the target faulty air cargo truck digital twin are identified, and the target faulty air cargo truck digital twin is deleted from the dispatched vehicle list property of the first target associated loader digital twin;
when the fault occurs type heavy truck fault, determining the target fault heavy truck digital twin and the second target fault heavy truck digital twin corresponding to the target fault heavy truck digital twin, and deleting the target fault heavy truck digital twin from the dispatched vehicle list property of the second target fault heavy truck digital twin, and reduce the completion of production.

7. The open-pit mine truck automatic dispatching system of claim 3, wherein the attribute information of the truck digital twin also includes the current position information of the truck, and the dispatcher digital twin is also used to determine the pending warning truck digital twin and the pending warning loader digital twin based on the current position information of the truck, the current position information of the loader and the search range;
the anti-collision warning information is sent to the digital twin of the waiting truck and the digital twin of the waiting loader.

8. The open-pit mine truck automatic dispatching system of claim 1, wherein the production plan includes a production end time, and the dispatcher digital twin is also used to send off orders to the loader digital twin and the truck digital twin when the time reaches the production end time;
the dispatcher digital twin is also used to respond to the exit notification of the driver terminal and send the exit notification to the loader digital twin and the truck digital twin;
the loader digital twin and the truck digital twin are used to respond to the exit notification and set their own state to offline.

9. The open-pit mine truck automatic dispatching system of claim 8, wherein the dispatcher digital twin is also used to destroy the loading machine digital twin, the unloading point digital twin, the truck digital twin, the transport path digital twin and the dispatcher digital twin when the loader digital twin and the truck digital twin are in an offline state.

10. An open-pit mine truck automatic dispatching method is applicable to the open-pit mine truck automatic dispatching system described in the claim 1, and the open-pit mine truck automatic dispatching method includes:
creating a dispatcher digital twin to receive a production plan based on the dispatcher digital twin, and create at least one loader digital twin, at least one unloading point digital twin, at least one truck digital twin, and at least one transportation path digital twin based on the production plan;
obtaining the available information for loaders and trucks and send the available information to the dispatcher digital twin;
controlling dispatcher digital twin generates dispatching instructions, the loader digital twin and the truck digital twin are dispatched based on the dispatching instruction, updating the property information of the loader digital twin, the unloading point digital twin, the truck digital twin, and the transportation path digital twin.
